(19) United States
(12) Patent Application Publication
(10) Pub. No.: US 2011/0016043 A1
(43) Pub. Date: Jan. 20, 2011

(54) ACCOUNT TRANSACTION VALUE ADDED TAX REIMBURSEMENT

(76) Inventor: Barbara Dornseif, Burlingame, CA (US)

Correspondence Address: Quarles & Brady LLP, TWO NORTH CENTRAL AVENUE, One Renaissance Square, PHOENIX, AZ, 85004-2391, US

(21) Appl. No.: 12/506,105

(22) Filed: Jul. 20, 2009

(51) Int. Cl. G06Q 40/00

(52) U.S. Cl. 705/39

(57) ABSTRACT

Transaction data is received and stored for purchases on accounts with authorization request requests for payment, where the currency of the purchase and the account are different. For each authorized transaction, clearing and settlement is facilitated as well as VAT reimbursement requests from different government entities. For each received VAT reimbursement request, it is determined whether the account is in a VAT reimbursement database, and if so then it is determined whether the data from the transaction is in a VAT reimbursement transactions database, and if so, then clearing and settlement of a VAT reimbursement payment is faciliated between the account and the corresponding government entity.

### FIELD

Various implementations, and combinations thereof, are related to a transaction processing system, and, more particularly, to a transaction processing system for initiating the reimbursement of certain transaction costs to a consumer.

### BACKGROUND

Many transactions for goods or services may be eligible for a reimbursement of a portion or the entire amount of the transaction. For example, in some transactions a tax or surcharge is applied to the final sale price which may ultimately be reimbursable to the consumer. If the consumer belongs to a particular class, or if the goods are of a certain type, the consumer may be able to submit receipts to a governmental agency for reimbursement. After the receipts are processed, a reimbursement check is sent to the consumer.

Generally, it takes a substantial amount of time and financial resources to process the reimbursement requests. Moreover, to minimize instances of fraud, a substantial amount of time and financial resources are required to review and validate the contents of each request. In some cases, it may even be necessary for a member of a governmental agency to physically inspect the items that were listed as part of the transaction. In addition to any submitted receipts, there may be additional forms or paperwork to be reviewed and verified. Only after all the information submitted in the request for reimbursement is reviewed and any necessary inspection of the purchased items is complete can the reimbursement request be processed. After processing, a reimbursement check is issued to the consumer.

Often, requests for reimbursements are filed in order to recoup the value of taxes paid in certain transactions. For example, some taxes paid on a transaction in a first country may be reimbursed if they are in-fact paid by individuals having a permanent residence in a second country. One such tax is the Value Added Tax (VAT) found in many European countries. VAT is a tax levied against the value added to certain goods or services. The VAT is collected via several partial payments made by each party involved in the production and/or distribution of a good or service. For example, in a transaction for the sale of goods, a portion of the tax is paid by each of the seller of the raw materials that make up the good, the manufacturer of the good, the retailer of the good, and, finally, the consumer.

VAT generally has limited applicability and is only applied in the sale of goods or services that are to be used within the country in which they are being sold. Goods or services that are consumed abroad are generally not subject to VAT. Because VAT does not apply to transactions where goods or services are provided to consumers residing in, or returning to foreign countries, a consumer in such a transaction can request reimbursement for the amount of VAT paid. For example, tourists traveling throughout Europe, where most countries use a VAT system, can apply for reimbursement of VAT that is paid upon returning to their place of residency in a non-European Union country.

To request reimbursement for VAT paid while in a foreign country, a tourist must satisfy several requirements. First, upon entering into a transaction with a merchant for goods or services, the tourist must first inform the clerk that the transaction will be subject to a VAT reimbursement request. In response, if the merchant participates in a VAT reimbursement process, the merchant will provide the tourist with a receipt that indicates the amount of VAT paid for the each of the goods or services included in the transaction. The merchant will also provide the tourist with VAT reimbursement forms which are to be submitted at a later time with the request for reimbursement. The forms will generally not be submitted for final processing until the tourist leaves the country, so they must be preserved by the tourist until that time. If the tourist visits several nations of the European Union (EU), the VAT reimbursement request is not to be submitted until the tourist leaves the last of the EU nations on the tourist's itinerary. At that time, VAT reimbursement requests for all the EU nations may be submitted.

At the time the tourist plans to leave the foreign country or the last EU nation on a particular journey, the tourist must collect all receipts and forms for any transactions subject to a VAT reimbursement request. If the tourist has made purchases in several EU nations, all receipts and forms for those purchases can be submitted at the same time. The receipts and forms are then submitted to a customs office at a port of egress to be used by the tourist. At that time, a customs officer may choose to inspect the tourist's belongings to ensure that the goods listed in the VAT reimbursement request are present. After review, inspection and approval, the receipts and forms are stamped by the customs agent.

With the stamped reimbursement forms, the tourist proceeds through security at the port of egress. Once through security, the stamped receipts and forms are submitted to a VAT refund agent located in a secured region of the port of egress. Depending upon the system, the refund agent may provide the tourist with an instant refund. However, in many cases the refund will be processed and issued as a check to the tourist, which may take several months to be processed and mailed.

The VAT reimbursement request process is laborious and time-consuming. A tourist wishing to request a refund of VAT must maintain an accurate record of purchases made and all records received as part of the transactions. With those records, the tourist must again go through a time-consuming process to initiate the payment of a refund, which can take many months to arrive.

Because the VAT reimbursement is so difficult, many tourists elect to avoid submitting VAT reimbursement requests, especially if the total value of the reimbursement would be relatively small. A more automated system, therefore, would be of benefit to tourists, business people, and other travelers to simplify the process of requesting reimbursements and to minimize the amount of time before a refund is received.

### SUMMARY

In one implementation, a payment authorization requests are received for a plurality of transactions on respective accounts. Each transaction is being conducted for a purchase from a merchant on a corresponding account, and each payment authorization request requests payment for the purchase from the corresponding account for the benefit of the merchant in a currency different than the currency of the corresponding account. In response to the payment authorization requests, the authorization requests are sent. In response to the authorization requests, authorization request responses for the plurality of transactions are sent. The authorization request responses are sent. A plurality of the authorization request responses are allowed such that the corresponding payment for the purchase is authorized to be paid from the corresponding account. For each transaction for which the authorization request response is allowed, clearing and settlement of the transaction is facilitated and it is determining whether the account of the transaction is in a Value Added Tax (VAT) reimbursement database, and if so then data from the transaction is stored in a VAT reimbursement transactions database. There is received, from a plurality of different government entities, a plurality of VAT reimbursement requests each corresponding to one transaction on one account. For each received VAT reimbursement request, it is determined whether the account of the transaction is in a Value Added Tax reimbursement database, and if so then it is determined whether the corresponding data from the transaction is stored in the VAT reimbursement transactions database, and if so, then clearing and settlement is facilited of the VAT reimbursement payment for the transaction between the account of the transaction and the corresponding said government entity.

### BRIEF DESCRIPTION OF THE DRAWINGS

Implementations will become more apparent from the detailed description set forth below when taken in conjunction with the drawings, in which like elements bear like reference numerals.

FIG. 1 shows a block diagram illustrating an exemplary reimbursement and payment processing system that enables a merchant to process transactions and initiate requests for reimbursement, the system includes a transaction handler that interfaces with a government tax authority and a customs terminal for processing and submitting the requests for VAT reimbursement;

FIG. 2 illustrates a detailed exemplary view of some of the components of a transaction handler, the transaction handler includes a processor, network or switch, and a database storage system.

FIG. 3 illustrates an exemplary method for processing a transaction, storing transaction data associated with the transaction, and submitting the transaction data in a request for VAT reimbursement.

FIG. 4 illustrates an exemplary method for conducting a transaction, if the transaction is eligible for VAT reimbursement, where the transaction data associated with the transaction is stored for later submission in a VAT reimbursement request.

FIG. 5 illustrates an exemplary method for initiating and processing a request for VAT reimbursement, where the requests are reviewed and approved via a customs terminal that interfaces with a transaction handler.

### DETAILED DESCRIPTION

A transaction processing system and method is described. The transaction processing system is configured to initiate the reimbursement of certain transaction costs to a consumer. The system maintains records of transactions entered into by a consumer and receives information describing one or more attributes of the transaction. If the transaction is eligible for at least partial reimbursement, the system may communicate with an issuer, merchant, or other party to the transaction to initiate payment of the reimbursement to the consumer. Depending upon the system, the merchant may be required to participate in the reimbursement program for reimbursement processing to take place. In one specific implementation, the system communicates with a customs officer for the processing of Value Added Tax (VAT) reimbursements. The customs official reviews a plurality of VAT reimbursement-eligible transaction receipts for approval. If approved, the system communicates with a governmental agency, an issuer, or other entity in communication with the present system to initiate reimbursement to the consumer.

The system receives requests for transaction authorizations from various merchants. The transactions are for the sale of goods and/or services and may involve additional fees or charges that are eligible for reimbursement. The system processes each request for authorization and indicates to the merchant whether the transaction is approved or denied. In addition to processing the request for authorization, the system determines whether the transaction is eligible for a reimbursement of VAT or other charges and also determines whether the consumer wishes to submit the transaction for reimbursement. If so, the system makes a record of all information necessary to submit the transaction for reimbursement. The record may include images or scans of the receipts that were ultimately issued to the consumer as part of the transaction.

After processing the request for authorization and storing data necessary for submitting a request for authorization, the system interacts with a governmental agency or customs official before processing the reimbursement requests. In the case of VAT reimbursements, the reimbursements are not processed until the system receives confirmation that the reimbursements are approved by a customs official and that the consumer is leaving the country in which the transactions took place—a legal requirement for most VAT reimbursements. For example, to satisfy VAT reimbursement requirements, the consumer enters passport and/or payment device information into a terminal located at an airport from which the consumer will leave the country. The terminal communicates with the present system to retrieve records of all transactions made by the consumer that are eligible for reimbursement. The transaction data is reviewed by a customs official via the terminal and any necessary inspections of the consumer's belongings are performed. Using the terminal, the customs official indicates which transactions are approved for reimbursement and confirms that the consumer is about to leave the country. Upon receiving confirmation and/or approval from the customs official, the system processes the requests for reimbursement. In one example, the reimbursement requests are submitted to a governmental tax authority which ultimately sends a reimbursement payment directly to the consumer. Alternatively, the reimbursement requests are submitted to the issuer of the consumer's payment account. In that case, the issuer sends a reimbursement payment directly to the consumer, for example by crediting the consumer's payment account directly, and then the issuers submits the reimbursement request to the governmental tax authority to be made whole. In that case, the governmental tax authority submits the reimbursement payment directly to the issuer. In other implementations, the VAT reimbursement payments are made by the merchants themselves, either directly to the consumer, or to the issuer of the consumer's payment account.

A computing apparatus executes software to facilate a VAT reimbursement payment to an account upon with a transaction with a merchant was conducted. The computing apparatus can be operated, for instance, for the benefit of a transaction handler or agent thereof, examples of which are Visa, Inc., American Express, Master Card, and other organization that process transactions on accounts between an issuer entity and an acquirer entity, or where such issuer and acquirer entities are the same entity. As such, the computing apparatus can be a sophisticated collection of networking devices in communication over one or more proprietary and public network.

In one implementation, a computing apparatus receives, from a plurality of different acquirers, a plurality of payment authorization requests for a plurality of transactions on respective accounts issued by a plurality of different issuers. Each transaction is being conducted for a purchase from a merchant on a corresponding account issued by one of the issuers to an account holder, where each authorization request requests payment for the purchase from the corresponding account to the corresponding acquirer for the benefit of the merchant. In this implementation, the requested payment is to be made in a currency that is different than the currency of the corresponding account.

The computing apparatus sends, in response to the payment authorization requests, the authorization requests to the respective issuers of the respective accounts upon which the plurality of transactions are being conducted. In response to the authorization requests, the computing apparatus receives authorization request responses from the respective issuers for the plurality of transactions. The authorization request responses are sent by the computing apparatus to the respective acquirers for the plurality of transactions, where a plurality of the authorization request responses are allowed such that the corresponding issuer has authorized the corresponding payment for the purchase from the corresponding account to the corresponding acquirer for the benefit of the merchant.

For each transaction for which the authorization request response is allowed, the computing apparatus facilitates the clearing and settlement of the transaction between the corresponding issuer of the account and the corresponding acquirer for the merchant. It is also determined whether the account of the transaction is in a Value Added Tax (VAT) reimbursement database, and if so then data from the transaction is stored in a VAT reimbursement transactions database.

The computing apparatus receives, from a plurality of different government entities, a plurality of VAT reimbursement requests. Each VAT reimbursement request corresponds to one of the transactions on one of the account. For each received VAT reimbursement request, the computing apparatus determines whether the account of the transaction is in a Value Added Tax reimbursement database, and if so then the computing apparatus determines whether the corresponding data from the transaction is stored in the VAT reimbursement transactions database. If so, then the computing apparatus facilitates a clearing and settlement of a VAT reimbursement payment for the transaction between the corresponding issuer of the account of the transaction and the corresponding government entity. As such, by the crediting by the issuer of the VAT reimbursement payment into the account of the account holder, the account holder is reimbursed for the VAT paid to the merchant with whom the account holder conducted the transaction.

In one implementation, the facilitating of the clearing and settlement of the transaction between the corresponding issuer and the corresponding acquirer includes the computing apparatus converting the currency of the purchase to the currency of the corresponding the account upon which the transaction was conducted with the merchant. By way of example, and not by way of limitation, the currency of each purchase can be Euros and each governmental entity can be a member of the European Community. Alternatively, each governmental entity need not be part of a member community such that there is no common currency among the governmental entities for which numerous VAT reimbursement payments are processed by the computing apparatus.

In one implementation, the facilitating of the clearing and settlement of the VAT reimbursement payment for the transaction between the corresponding issuer of the account of the transaction and the corresponding government entity includes sending a VAT reimbursement amount request for delivery to the corresponding government entity, then receiving, in response to the VAT reimbursement amount request, the VAT reimbursement payment, and then sending the VAT reimbursement payment, for delivery to the issuer of the account of the transaction, to credit to the account upon which the transaction was conducted with the merchant. Optionally, the computing apparatus can also convert the VAT reimbursement payment into the currency of the corresponding the account upon which the transaction was conducted with the merchant.

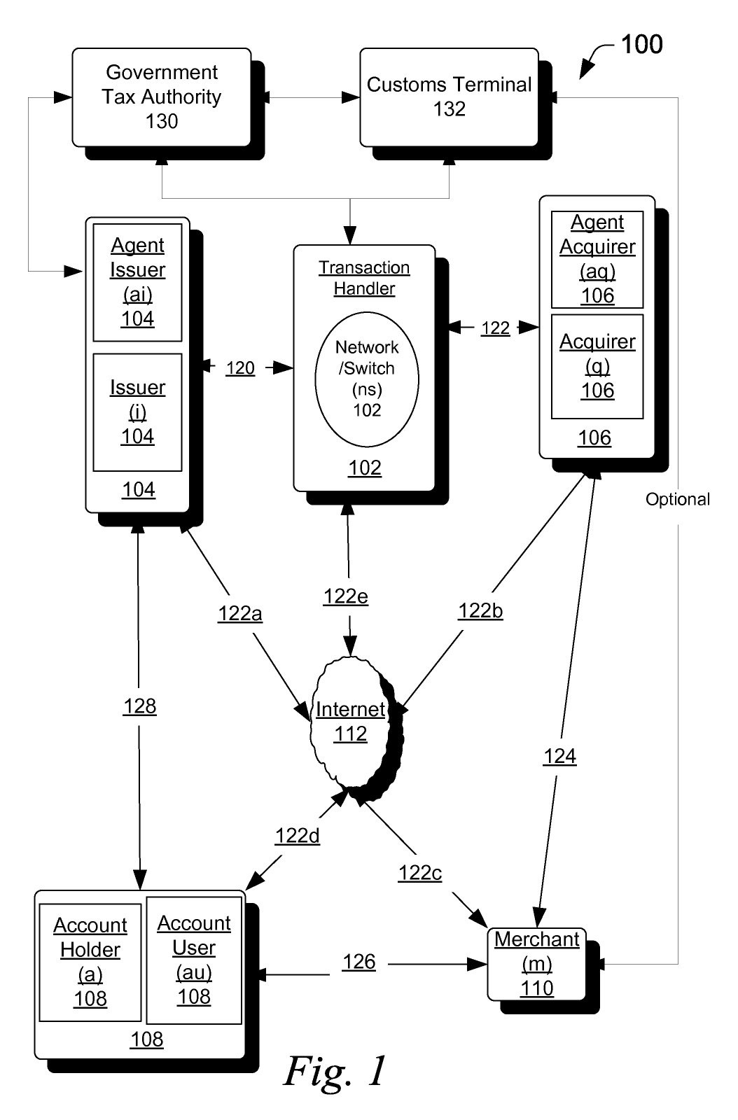

FIG. 1 illustrates an exemplary system 100 for processing transactions and initiating the reimbursement of certain transaction costs to a consumer and depicts a general environment in which a merchant (m) 110 can conduct a transaction for goods and/or services with an account user (au) or customer on an account (e.g., a prepaid account, credit account, points account, etc.) issued to an account holder (a) or customer 108 by an issuer (i) 104, where the processes of paying and being paid for the transaction are coordinated by a transaction handler 102. In the present system, a transaction includes participation from different entities that are each a component of the reimbursement and payment processing system 100.

Reimbursement and payment processing system 100 has a plurality of merchants 110 that includes merchant (1) 110 through merchant (M) 110, where M can be up to and greater than an eight digit integer.

Reimbursement and payment processing system 100 has a plurality of accounts 108 each of which is held by a corresponding account holder (1) 108 through account holder (A) 108, where A can be up to and greater than a ten digit integer.

Reimbursement and payment processing system 100 includes account user (1) 108 through account user (AU) 108, where AU can be as large as a ten digit integer or larger. Each account user (au) may act as a customer and initiate a transaction for goods and/or services with merchant (m) 110 using an account that has been issued by an issuer (i) 104 to a corresponding account holder (a) 108. Data from the transaction on the account is collected by merchant (m) and forwarded to a corresponding acquirer (a) 106. Acquirer (a) 106 forwards the data to transaction handler 102 for facilitating payment of the transaction from the account issued by the issuer (i) 104 to account holder (a) 108 and initiating reimbursement, if eligible. In some implementations, transaction data is transmitted directly to transaction handler 102 by merchant 110.

Reimbursement and payment processing system 100 has a plurality of issuers 104. Each issuer (i) 104 may be assisted in processing one or more transactions by a corresponding agent issuer (ai) 104, where ‘i’ can be an integer from 1 to I, where ‘ai’ can be an integer from 1 to AI, and where I and AI can be as large as an eight digit integer or larger.

Reimbursement and payment processing system 100 has a plurality of acquirers 106. Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as a eight digit integer or larger.

Reimbursement and payment processing system 100 has a transaction handler 102 to process a plurality of transactions. The transaction handler 102 can include one or a plurality or networks and switches 102. Each network/switch (ns) 102 can be a mainframe computer in a geographic location different than each other network/switch (ns) 102, where ‘ns’ is an integer from one to NS, and where NS can be as large as a four-digit integer or larger.

To process reimbursement transactions, transaction handler 102 is in communication with government tax authority 130 and customs terminal 132. Government tax authority 130 may receive requests for reimbursement from transaction handler 102 or issuer 104 and provides an authoritative evaluation of the propriety of issuing such a reimbursement. In some implementations, government tax authority 130 includes a non-government entity for evaluating the reimbursement requests. In other alternative implementations, transaction handler 102 includes a database of rules which are used to determine whether a particular transaction is reimbursement-eligible. Transaction handler 102 also communicates with customs terminal 132. Customs terminal 132 provides a user interface for allowing a customs official to review the contents of a request for reimbursement and execute any necessary inspection to determine whether to approve the request.

Dedicated communication systems 120, 122 (e.g., private communication network(s)) facilitate communication between the transaction handler 102 and each issuer (i) 104 and each acquirer (a) 106. The Internet 112, via e-mail, the World Wide Web, cellular telephony, and/or other optional public and private communications systems, can facilitate communications using communication systems 122a-122e among and between each issuer (i) 104, each acquirer (a) 106, each merchant (m) 110, each account holder (a) 108, and the transaction handler 102. Alternatively and optionally, one or more dedicated communication systems 124, 126, and 128 can facilitate respective communications between each acquirer (a) 106 and each merchant (m) 110, each merchant (m) and each account holder (a) 108, and each account holder (a) 108 and each issuer (i) 104, respectively. Similar communication systems provides for the transfer or data between issuer 104, government tax authority 130, transaction handler 102 and customs terminal 132.

Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as a eight digit integer or larger.

Merchant (m) 110 may be a person or entity that sells goods and/or services. Merchant (m) 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 108 may be a second merchant making a purchase from another merchant (m) 110. Merchant (m) 110 may use at least one point-of-sale terminal (POS) that can communicate with acquirer (a) 106, transaction handler 102, or issuer (i) 104. Thus, the POS terminal is in operative communication with the reimbursement and payment processing system 100.

Typically, a transaction begins with account user (au) 108 presenting a portable consumer payment device to merchant (m) 110 to initiate an exchange for a good or service. The payment device may be associated with an account (e.g., a monetary or reward points account) of account holder (a) 108 that was issued to the account holder (a) 108 by issuer (i) 104.

The payment device may be in a form factor that can be a payment card, a gift card, a smartcard, a smart media device, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or the name of an account holder (a) 108.

Merchant (m) 110 may use the POS terminal to obtain account information, such as a number of the account of the account holder (a) 108, from the payment device. The payment device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 104 of the account corresponding to the portable consumer payment device. Alternatively, or in combination, the payment device may communicate with issuer (i) 104, transaction handler 102, or acquirer (a) 106.

Issuer (i) 104 may authorize the transaction using transaction handler 102. Transaction handler 102 may also clear the transaction. Authorization includes issuer (i) 104, or transaction handler 102 on behalf of issuer (i) 104, authorizing the transaction in connection with issuer (i) 104's instructions such as through the use of rules such as business rules or the application of legal requirements such as laws, ordinances, or other governmental requirements. The rules could include instructions or guidelines from transaction handler 102, account holder (a) 108, merchant (km) 110, acquirer (a) 106, issuer (i) 104, a related financial institution, government tax authority 130 or customs terminal 132, or combinations thereof. Transaction handler 102 may maintain a log or history of authorized transactions. Once approved, merchant (m) 110 will record the authorization, allowing account user (au) 108 to receive the good or service from merchant (m) or an agent thereof.

Merchant (m) 110 may, at discrete periods, such as at the end of the day, submit a list of authorized transactions to acquirer (a) 106 or other transaction related data for processing through the reimbursement and payment processing system 100. Transaction handler 102 may compare the submitted authorized transaction list with its own log of authorized transactions. If a match is found, transaction handler 102 may route authorization transaction amount requests from the corresponding acquirer (a) 106 to the corresponding issuer (i) 104 involved in each transaction. Once acquirer (a) 106 receives the payment of the authorized transaction amount from issuer (i) 104, acquirer (a) 106 can forward the payment to merchant (m) 110 less any transaction costs, such as fees for the processing of the transaction. If the transaction involves a debit or prepaid card, acquirer (a) 106 may choose not to wait for the issuer (i) 104 to forward the payment prior to paying merchant (m) 110.

Reimbursement and payment processing system 100 may also process reimbursement requests for transactions between customer 108 and merchant 110. Merchant 110 operates a POS system for collecting information from customer 108 via a payment device, or other customer identification device such as a passport, driver's license, or other government-issued identification. If the transaction includes a request for reimbursement such as a request for VAT reimbursement, merchant 110 may include the request for reimbursement and the user identification information in the transaction data transmitted to transaction handler 102 via the corresponding a merchant's acquirer in the request for authorization. Alternatively, transaction handler 102 reviews customer 108 details stored in a locally accessible database to determine whether customer 108 wishes to submit reimbursement requests for any or all eligible requests. After receipt, transaction handler 102 maintains a record of the transaction data that may be used for processing VAT reimbursement requests.

To process the reimbursement requests, transaction handler 102 communicates with customs terminal 132 to allow a customs official to review the transaction data embodied within the reimbursement request. The customs official may also perform any required inspections of the goods that are the subject of the reimbursement request. After receiving sufficient authorization via customs terminal 132, transaction handler 102 communicates with issuer 104 or government tax authority 130 to initiate a reimbursement payment to customer 108.

There may be intermittent steps in the foregoing process, some of which may occur simultaneously. For example, acquirer (a) 106 can initiate the clearing and settling process, which can result in payment to acquirer (a) 106 for the amount of the transaction. Acquirer (a) 106 may request from transaction handler 102 that the transaction be cleared and settled. Clearing includes the exchange of financial information between the issuer (i) 104 and the acquirer (a) 106 and settlement includes the exchange of funds. Transaction handler 102 can provide services in connection with settlement of the transaction. The settlement of a transaction includes depositing an amount of the transaction settlement from a settlement house, such as a settlement bank, which transaction handler 102 typically chooses, into a clearinghouse, such as a clearing bank, that acquirer (a) 106 typically chooses. Issuer (i) 104 deposits the same from a clearinghouse, such as a clearing bank, which issuer (i) 104 typically chooses, into the settlement house. Thus, a typical transaction involves various entities to request, authorize, and fulfill processing the transaction.

Reimbursement and payment processing system 100 has various network components suitable for scaling the number and data payload size of transactions that can be authorized, cleared and settled in both real time and batch processing. These include hardware, software, data elements, and storage network devices for the same.

Each network/switch (ns) 102 can include one or more data centers for processing transactions, where each transaction can include up to 100 kilobytes of data or more. The data corresponding to the transaction can include information about the types and quantities of goods and services in the transaction, information about the account holder (a) 108, the account user (au) 108, the merchant (m) 110, tax and incentive treatment(s) of the goods and services, coupons, rebates, rewards, loyalty, discounts, returns, exchanges, cash-back transactions, etc.

By way of example, network/switch (ns) 102 can include one or more mainframe computers (e.g., one or more IBM mainframe computers) for communications over systems 120, 122, one or more server farms (e.g., one or more Sun UNIX Superservers), where the mainframe computers and server farms can be in diverse geographic locations.

Each issuer (i) 104 (or agent issuer (ai) 104 thereof) and each acquirer (a) 106 (or agent acquirer (aq) 106 thereof) can use one or more router/switch (e.g., Cisco routers/switches) to communicate with each network/switch (ns) 102 via dedicated communication systems 120, 122, respectively.

The VisaNet® system is an example component of the transaction handler 102 in the payment processing system 100. Presently, the VisaNet® system is operated in part by Visa Inc. As of 2007, the VisaNet® system Inc. was processing around 300 million transaction daily, on over 1 billion accounts used in over 170 countries. Financial instructions numbering over 16,000 connected through the VisaNet® system to around 30 million merchants. In 2007, around 81 billion transactions for about 4 trillion U.S. dollars were cleared and settled through the VisaNet® system, some which involved a communication length of around 24,000 miles in around two (2) seconds.

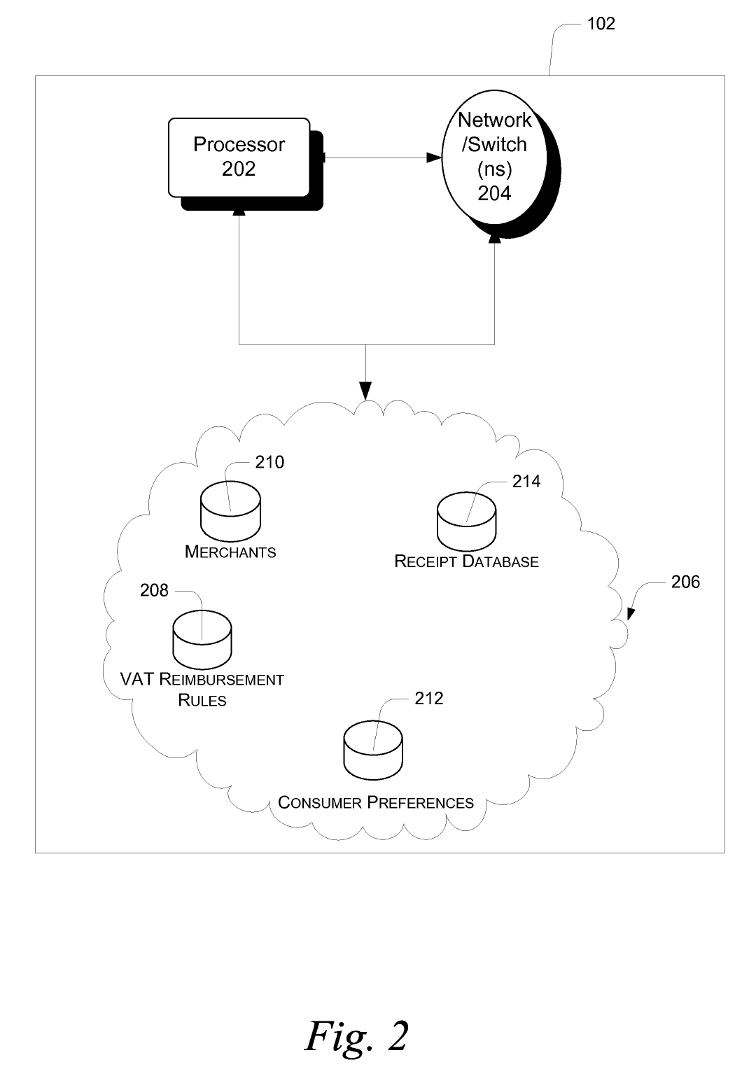

FIG. 2 illustrates a more detailed exemplary view of the exemplary transaction handler 102. Transaction handler 102 includes processor 202 for executing software code to implement the functionality of transaction handler 102. Processor 202 may include a single computer processor, or a plurality of processors distributed throughout a plurality of computers, mainframes, and/or servers. Processor 202 communicates with one or more databases of computing cloud 206 for storage and retrieval of data and content in accordance with the operation of system 100. Database system 206 may include a plurality of storage sub-systems for the operation of system 100. VAT reimbursement rules 208 include a plurality of rules for determining whether a particular transaction is eligible for VAT reimbursement. The rules may define a transaction amount, residency requirements for consumer 108, eligible products or goods, eligible or participating merchants and other information for determining whether a transaction is eligible for reimbursement. Merchants database 210 stores a listing of merchants participating in the present system. Consumer preferences database 212 stores a listing of preferences for each consumer 108 relating to whether to submit VAT reimbursements for eligible transactions. Using a user interface provided by transaction handler 102 or another entity participating in system 100, consumer 108 can log-in and select various VAT reimbursement preferences. Depending upon the system implementation, the consumer preferences may specify that VAT reimbursement requests should be processed for transactions over a certain amount, all transactions, no transactions, transactions entered into in a particular country or collection of countries, transactions entered into with a specific portable consumer payment device (e.g., a particular credit card, checking card, or rewards points card), transactions occurring between a certain date range, or any combination thereof, for example. Receipt database 214 stores transaction data and other information for processing reimbursement requests for VAT reimbursement-eligible transactions.

Network or switch 204 is in communication with processor 202 and database system 206. Network 204 allows processor 202 to communicate with other components of system 100. Furthermore, because network 204 is in direct communication with database 206, other components of system 100 may communicate directly with database 206. In other implementations, however, to ensure security, the other components of system 100 are not given access to database 206. Instead, they must issue requests for information, or to store data, to processor 202 which ultimately determines whether to fulfill the request.

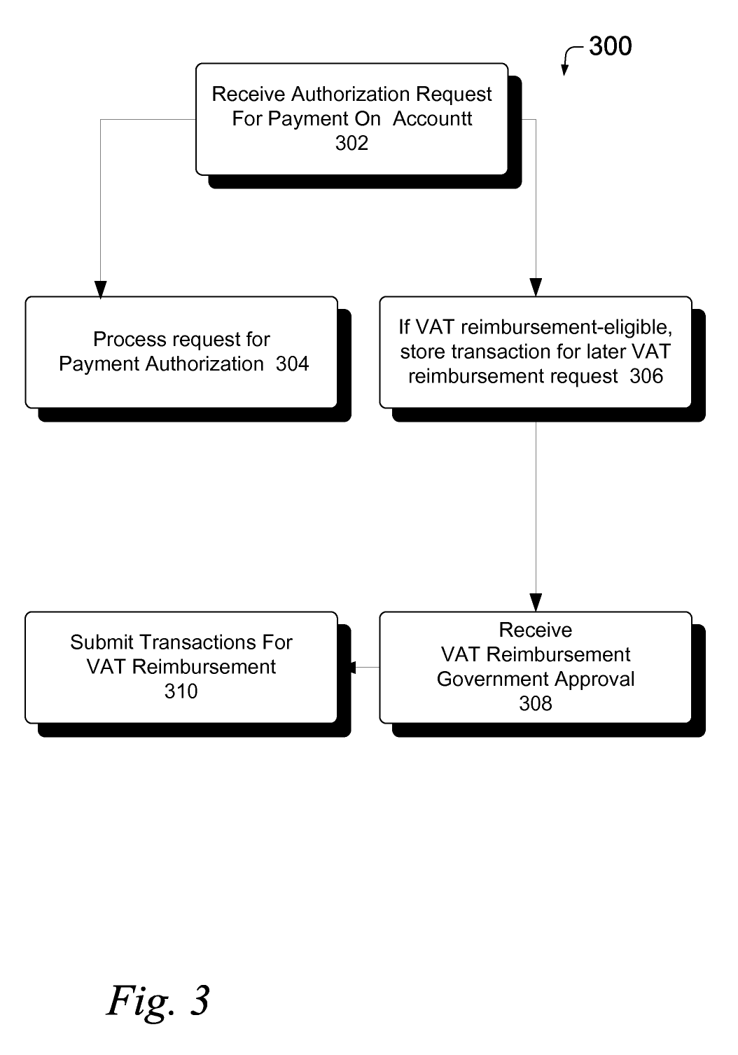

FIG. 3 is a flowchart illustrating an operation of system 100. In a first step 302 transaction handler 102 receives a request for authorization from merchant 110. The request for authorization includes transaction data describing a transaction to be entered into between merchant 110 and consumer 108. The transaction data includes a total price, consumer 108's payment account information, and any other information necessary to process the request for authorization, such as consumer 108's identification information.

In step 304, system 100 processes the request for authorization by communicating with an issuer 104 of consumer 108's payment account. To process the request for authorization, the transaction data is transmitted to issuer 104. Issuer 104 receives the transaction data and inspects consumer 108's payment account to determine whether to approve the purchase. If so, issuer 104 notifies transaction handler 102, which forwards the approval to merchant 110. With an approval, merchant 110 executes the transaction and transfers the goods or services to consumer 108.

Step 306 involves determining whether to also process the transaction for VAT reimbursement. If so, system 100 stores the transaction data and any other information necessary to process a request for VAT reimbursement. Depending upon the implementation, the request for authorization received from merchant 110 may indicate that the transaction should be processed for VAT reimbursement. Alternatively, system 100 may process all transactions for VAT reimbursement or inspect the details of the transaction to determine whether the transaction satisfies various local laws or regulations for VAT reimbursement. If so, the transaction may be automatically processed for reimbursement. Alternatively, transaction handler 102 may access a consumer preferences database to determine whether consumer 108 wishes to submit the transaction for VAT reimbursement. The consumer preferences may include a plurality of rules against which the transaction can be compared to make the determination of whether to process a VAT reimbursement for the transaction. If the transaction is to be processed for VAT reimbursement, the transaction data is stored for later submission with the VAT reimbursement request.

After storing the transaction details for VAT reimbursement requests, the system 100 may wait for approval before submitting the reimbursement requests to the appropriate entity for payment to the consumer 108. In one implementation, the system waits for approval from a customs official in step 308. The approval process may require system 100 to transmit the transaction data for all VAT reimbursement-eligible transactions for review by the customs official. After receiving the listing of transactions, the customs official reviews the transactions and consumer 108's goods to verify that all requirements for VAT reimbursement are satisfied. If so, the customs official informs system 100 that the reimbursements are approved. Depending upon the implementation, the customs official may use any user interface to communicate with system 100 such as a website, cell-phone interface, customer service representative or other system for capturing data from the customs official. After receiving approval from the customs official, the system forwards the VAT reimbursement requests to an appropriate entity for processing and payment of the reimbursement to consumer 108 in step 310. In other implementations, the VAT reimbursement requests are submitted to the appropriate entity for payment to consumer 108 without any review process, or any period of delay before submission.

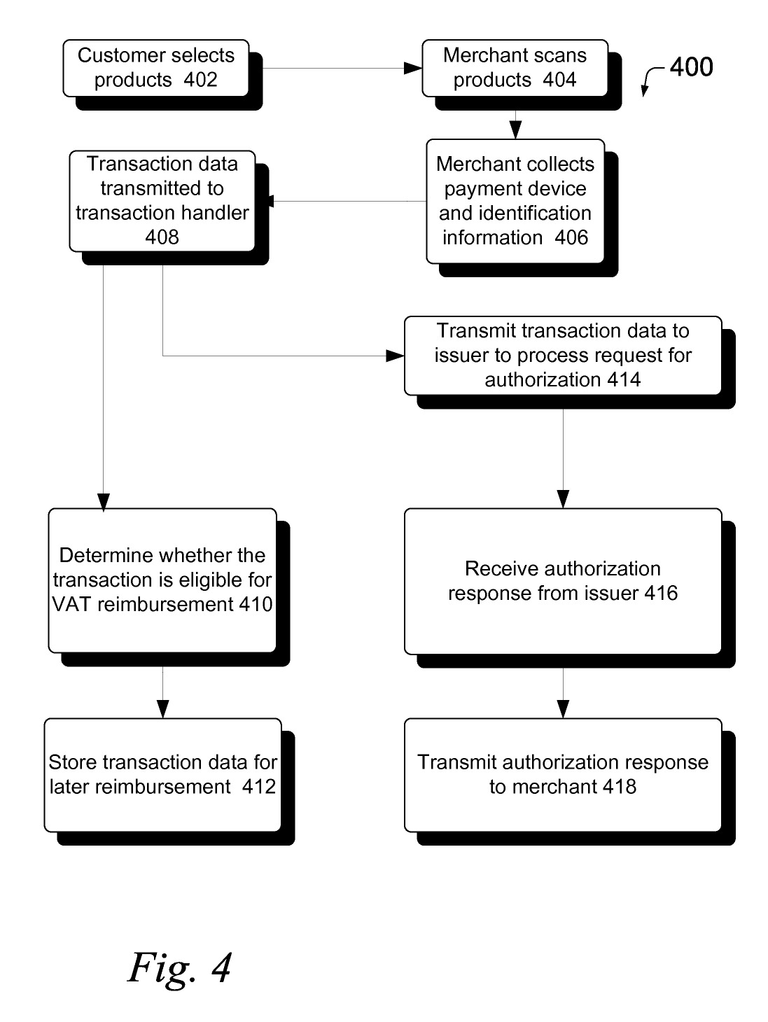

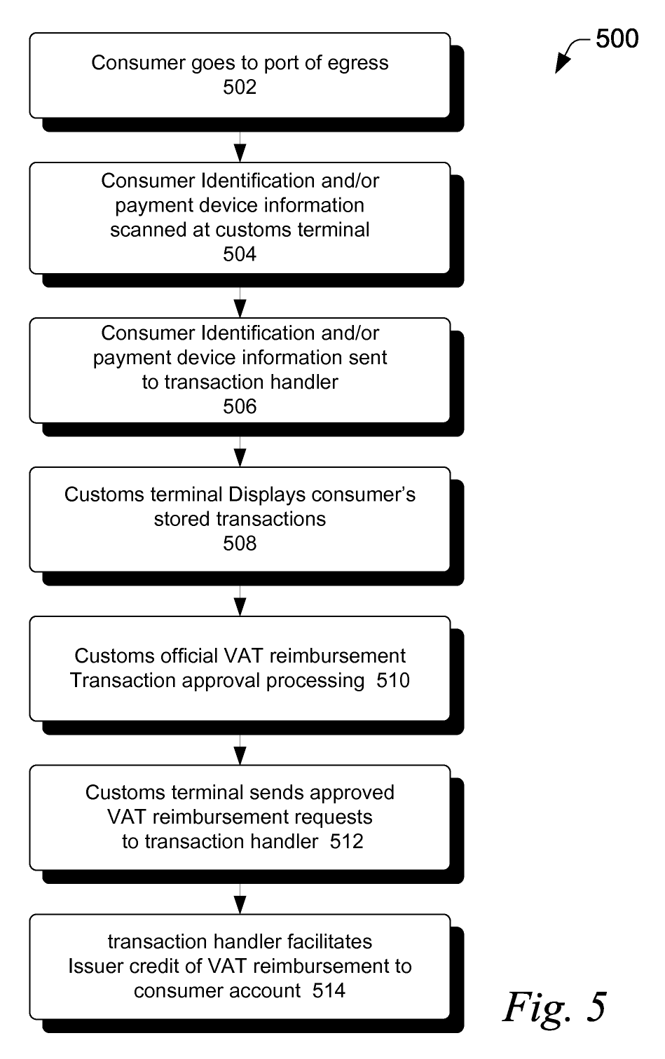

FIG. 4 illustrates an exemplary method 400 for conducting a transaction wherein a portion of the transaction is eligible for a reimbursement. Transaction details are stored by transaction handler 102 and, if approved, are later submitted to an appropriate entity in a request for reimbursement (as illustrated by FIG. 5). The method illustrated in FIG. 4 is approximately encompassed within blocks 302, 304 and 306 of FIG. 3. In the present method, the transaction is for the sale of goods or services and includes a VAT charge. The VAT charge may be reimbursed to the consumer depending on the status of the consumer and the local rules and regulations that apply to the reimbursement of VAT charges.

Consumer or account holder 108 first selects various goods or services to be purchased from a merchant 110 in step 402. Merchant 110 is participating in the present reimbursement program. The total cost of the transaction includes a VAT amount applied to the cost of the goods or services being purchased. Typically, merchant 110 is located in a first country and consumer 108 is a foreigner having a place of permanent residency in a second country. The first country applies VAT to transactions for goods or services. Because consumer 108 is a traveler and intends to return to consumer 108's country of permanent residency, consumer 108 may be eligible for a reimbursement of the VAT charges applied to the transaction. If the transaction is for services, however, the transaction may be eligible for VAT reimbursement if the services are provided to consumer 108 in a country other than that of merchant 110, for example, in the country of consumer 108's permanent residency.

In step 404, merchant 110 scans the products or services to be purchased to calculate a total amount due using a POS or other customer interaction device. In some cases, the advertised costs of the goods or services already include a VAT charge that is eligible for reimbursement. In other implementations, however, the POS calculates an appropriate VAT charge for each product or service at the time the products or services are scanned. Depending on the VAT regime, different VAT amounts or percentages may be charged for each good or service depending upon the class of goods or services being purchased. After scanning the products and services in step 404, merchant 110 generates a total amount due.

In step 406, merchant 110 collects consumer 108's payment information and, optionally, consumer 108 identification information for executing the transaction for goods and services. In one implementation, merchant 110's POS communicates with consumer 108's portable consumer payment device to retrieve the payment account information. For example, the POS may read a magnetic strip on a payment account card carried by consumer 108. In other systems, however, the account information is communicated to merchant 110 verbally, or through another input mechanism (such as a mechanical keypad, cellular telephony interface or voice recognition system). In some cases, consumer 108's phone number, rewards card number, or other information may be used to identify consumer 108's payment account.

At the time the transaction is executed, consumer 108 may inform merchant 110 that the transaction is eligible for VAT reimbursement. If so, in accordance with local regulations, and if merchant 110 participates in the reimbursement program, merchant 110 may collect identification and/or residency information for consumer 108. The identification information may be scanned or keyed into merchant 110's POS system from consumer 108's passport, driver's license, or other government-issued identification device. Alternatively, consumer 108's portable consumer payment device, such as a credit card, may encode information identifying consumer 108's citizenship, country of origin, or place of permanent residency. In other systems, consumer 108 verbally instructs merchant 110 as to the place of permanent residency of consumer 108, in which case the information is manually entered into merchant 110's POS by merchant 110, or collected via a voice recognition system.

Having retrieved the payment account information, consumer 108's identification or residency information, an indication of whether consumer 108 intends to process the transaction for VAT reimbursement, and any other transaction-related data, merchant 110 initiates a payment transaction process to complete the exchange of goods and services. In step 408, merchant 110 transmits the transaction data to transaction handler 102 (in some cases the information is routed through acquirer 106) in a request for authorization. The transaction data may include a listing of goods or services to be purchased, an itemized VAT amount applied to each good and/or service, a total transaction amount, consumer 108's payment account information, information describing merchant 110 including merchant 110's location, consumer 108's identification information, an indication of whether the transaction is eligible for VAT reimbursement, the parties involved, the goods or services being exchanged, and any other information describing the transaction. The request for authorization is transmitted to transaction handler 102 using Internet 112, dedicated communication systems 120 and/or 122, or another communication medium.

In other system implementations, the information necessary for VAT reimbursement may be transmitted to transaction handler 102 in a separate communication rather than being included with the request for authorization. In order to maximize network performance by minimizing network traffic, for example, the request for payment authorization may include only the minimum information necessary to determine whether payment is authorized and to execute the transaction. By including only the minimum information, network delay is minimized and the transaction is authorized in as short amount of time as possible, thus greatly improving consumer 108's experience. In that case, the VAT reimbursement information may be transmitted at a later time and not as part of the transmission required for authorizing the transaction, such as consumer 108's identification information, the amount of VAT applied to each product or service being purchased, the indication that the request is for VAT reimbursement, and any other information required for processing the reimbursement request.

In step 410, transaction handler 102 receives the transaction data from merchant 110 and determines whether the transaction is eligible for VAT reimbursement, and/or whether VAT reimbursement has been requested. In one implementation, transaction handler 102 inspects the transaction data received from merchant 110 to determine whether the transaction data includes a flag or other data packet indicating that consumer 108 intends to submit the transaction for VAT reimbursement. If the flag is present, the transaction is processed for VAT reimbursement. If, however, the flag is missing, the transaction is processed as normal with no VAT reimbursement processing.

In other system 100 implementations, however, transaction handler 108 independently determines whether the transaction is eligible for VAT reimbursement and/or whether consumer 108 wishes the transaction to be processed for VAT reimbursement. As such, the transaction data received from merchant 110 need not include specific VAT reimbursement instructions. Instead, transaction handler 102 may rely upon a local database of consumer 108 preferences to determine whether a particular consumer 108 wishes to submit their purchases for VAT reimbursement. The consumer preferences database is in communication with transaction handler 102 and identifies each consumer 108 and their preferences for VAT reimbursement. After receiving a request for authorization from merchant 110, transaction handler 102 uses consumer 108 identification information, account information, or other information included within the transaction data to identify a consumer preference account associated with consumer 108. The reimbursement preferences for consumer 108 are identified by consumer 108's payment account number, identification information, or any other data identifying consumer 108. Alternatively, VAT reimbursement preferences may be established for groups of consumers 108. Using the database of reimbursement preferences, transaction handler 102 retrieves preference information for consumer 108 to determine whether consumer 108 wishes to request VAT reimbursement for the transaction.

To implement the consumer preferences database, transaction handler 102 provides a website or other user interface allowing consumer 108 to specify reimbursement preferences. Depending upon the system, the user interface may be provided via a website, cell-phone interface, customer service representative or other system for capturing data from consumer 108. Alternatively, issuer 104 associated with consumer 108's payment account may transmit VAT reimbursement preferences to transaction handler 102 for entry into the consumer preferences database. Consumer 108's VAT reimbursement preferences can include any appropriate rule or combination of rules for determining whether to submit any particular transaction for VAT reimbursement. For example, consumer 108 may use the user interface provided by transaction handler 102 to specify that VAT reimbursement requests should be processed for transactions over a certain amount, all transactions, no transactions, transactions entered into in a particular country or collection of countries, transactions entered into with a specific portable consumer payment device (e.g., a particular credit card, checking card, or rewards points card), transactions occurring between a certain date range, or any combination thereof.

In other implementations, transaction handler 102 automatically evaluates whether a transaction is eligible for VAT reimbursements and processes it as such, with no consumer 108 input. For example, after receiving a request for transaction authorization including transaction data, transaction handler 102 may first determine a location where the transaction took place by reviewing the transaction data to determine a location of merchant 110. After establishing the location of the transaction, transaction handler 102 can review consumer 108's account information to determine a place of permanent residency of consumer 108. For example, transaction handler 102 may retrieve the mailing address for consumer 108, citizenship information of consumer 108, or otherwise identify a residency location of consumer 108. If the transaction location is one in which VAT is added to the final cost of goods and services, consumer 108's residency information meets formal requirements, and the jurisdiction in which the transaction takes place allows VAT reimbursements, transaction handler 102 may automatically initiate the VAT reimbursement process for the transaction on behalf of consumer 108. To automatically determine whether a transaction is eligible for VAT reimbursement, transaction handler retrieves reimbursement rules from VAT reimbursement rules database 208. The rules are then applied to the transaction data, and transaction handler 102 determines whether the transaction is eligible.

In the event that transaction handler 102 determines that a transaction is eligible for VAT reimbursement and that consumer 108 wishes to submit the transaction for reimbursement, transaction handler 102 stores the transaction data in a transaction database in step 212 for later reimbursement processing, for example by storing the data in receipts database 214. Generally, transaction handler 102 stores all transaction data received from merchant 110 necessary to perform VAT reimbursement. In some cases, this includes an image or scanned copy of the original receipt provided to consumer 108 that contains a record of the transaction. If required by the jurisdiction, copies of receipts identifying each product or service purchased and the amount of VAT added for each product or service are stored with the transaction data by transaction handler 102. In most cases, because merchants 110 must meet their own jurisdiction's requirements for data collection and processing for VAT reimbursements, all necessary information is available to merchants 110 and may be submitted by merchants 110 to transaction handler 102 as part of the request for authorization either within the transaction data, or in a separate transmission at another time. With the data for VAT reimbursement-eligible transactions stored in a database accessible to transaction handler 102, reimbursement and payment processing system 100 waits for appropriate authorization before submitting the reimbursement process.

In addition to determining whether VAT reimbursement data is to be stored in receipt database 214 for the instant transaction, transaction handler 102 continues with processing merchant 110's request for authorization. As discussed above, the analysis for VAT eligibility and the processing of the merchant 110's request for authorization may take place at approximately the same time as part of a single transaction. When processing transactions that are eligible for reimbursement, as a compensation model for merchants 110, the interchange fees normally charged for use of transaction handler 102 may be waived. Alternatively, if normal interchange fees are paid, merchants 110 may be compensated by a percentage of the total VAT reimbursement charges ultimately paid to consumer 108.

In step 414, to process the request for authorization, transaction handler 102 inspects the transaction data included within the request for authorization received from merchant 110 to identify and communicate with issuer 104 of consumer 108's payment account. Depending upon the system implementation, consumer 108's account information may be included within the request for authorization, or in a separate transmission communicated at a different time, and may directly encode the identity and contact information of the account's issuer 104, such as by including routing information or a bank identification number (BIN) in the transaction data. In other implementations, however, transaction handler 102 performs a look-up on a database of issuers 104 to identify which issuer 104 is responsible for consumer 108's account. For example, if the transaction request includes a user identification code to identify consumer 108, transaction handler 102 searches through the database to find the issuer 104 maintaining consumer 108's payment account.

After retrieving the contact information for issuer 104 of consumer 108's account, transaction handler 102 transmits the request for authorization and associated transaction data to issuer 104 via Internet 112 or other communication medium such as via dedicated communication system 120 or 122. In some cases, transaction handler 102 supplements the transaction information included within the request for authorization with additional data describing consumer 108's loyalty program memberships, consumer 108's other transactions for similar goods, consumer 108's interaction with other similar merchants 110, or any other information describing consumer 108's previous transaction history, for example.

In the event that issuer 104 cannot be contacted or is unable to process the request for authorization (for example, if Internet 112 or dedicated communication systems 120 or 122 are unavailable or inactive, or issuer 104 is otherwise unresponsive), transaction handler 102 may use a stand-in processing (STIP) algorithm to provide temporary authorization for the transaction. To determine whether STIP is available, transaction handler 102 reviews the details of the request for authorization received from merchant 110, in addition to other transaction details, to determine whether the transaction meets certain STIP requirements. For example, if the total value of the transaction is under a defined dollar amount or involves a certain category of goods or services, the transaction may be authorized by STIP. If the transaction does not meet the requirements for STIP and is not authorized, transaction handler 102 informs merchant 110 that the transaction is denied, and merchant 110 takes appropriate action. If the transaction is approved by STIP, merchant 110 is informed that the transaction is approved and merchant 110 acts accordingly. In transactions approved by STIP, a later-occurring clearance and settlement process is used to ensure that the necessary funds are exchanged between issuer 104 and acquirer 106 to compensate acquirer 106 for the total value of the transaction. If the transaction is denied, the system 100 does not store information for VAT reimbursement or otherwise proceed with executing a VAT reimbursement request. In other implementations, STIP requests are received and processed using consumer 108's personal payment device via an electronic circuit, processor or memory system embodied thereon.

After receiving the request for authorization and transaction information from transaction handler 102, issuer 104 of consumer 108's account retrieves consumer 108's account information to determine whether to approve the transaction. The account information may include a monetary value or a number of points having a monetary value. At this time, any necessary currency conversions may be applied to the monetary value stored in consumer 108's account. If consumer 108's payment account has sufficient funds, the transaction is approved.

After approving a transaction, issuer 104, if applicable, deducts the appropriate monetary value from customer 108's payment account and transmits a transaction authorization response to transaction handler 102 in step 316. If the transaction is approved, issuer 104 notifies transaction handler 102 that the transaction is approved. Alternatively, if the transaction is denied, issuer 104 notifies transaction handler 102 that the transaction is denied. If the transaction is denied, system 100 does not store information for VAT reimbursement, or otherwise proceed with executing a VAT reimbursement request.

In processing the transaction, issuer 104 may transmit additional information back to transaction handler 102 in response to the transaction request. Additional data may include the current balance of customer 108's account (for example, in response to a balance inquiry submitted via merchant 110). In some cases, in addition to an approval or denial of the transaction, issuer 104 sends special instructions to transaction handler 102 in response to the transaction request. The additional data may include instructions to provide bonuses or other special treatment to consumer 108 such as access to a special check-in line, special check-out line, a waiver of the requirement that consumer 108 have a ticket for a particular event, a free or complimentary purchase or service, or instructions to provide consumer 108 with a free gift. In other implementations, the additional data may include any information or intelligence relating to the goods or services involved in the transaction, consumer 108, or merchant 110 that are accessible to issuer 104.

After receiving the transaction authorization or denial and any other data transmitted by issuer 104 in response to the request for authorization to transaction handler 102, transaction handler 102 forwards the information to merchant 110 in step 418.

In some implementations of the present system, the information forwarded to merchant 110 takes the form of conventional transaction approval or denial messages used for credit card/debit card transactions or transactions associated with other payment instruments and payment processing networks. In other implementations of the system, however, the information forwarded to merchant 110 includes both the approval or denial message encoded in a proprietary manner, an account balance, and/or any other information provided by issuer 104 such as a description of special instructions for customer service.

Merchant 110 receives the transaction authorization or denial from transaction handler 102 and processes the transaction accordingly. In the present example, merchant 110 provides consumer 108 with all receipts and paperwork necessary for submitting a VAT reimbursement request for the consumer 108's records. Merchant 110 may also retrieve any additional information (including any special instructions) included with the transaction authorization or denial received from transaction handler 102. In accordance with the special instructions or other information, merchant 110 may provide additional services or provide additional goods to consumer 108, or otherwise modify consumer 108's experience.

FIG. 5 illustrates an exemplary method 500 of processing VAT reimbursement requests for the transactions identified and stored by system 100. As shown in FIG. 5, after shopping within a particular country or collection of countries and entering into one or more transactions that are eligible for VAT reimbursement, consumer 108 can initiate the process of requesting reimbursement for those transactions. Generally, before initiating reimbursement, consumer 108 must demonstrate egress from the country (or collection of countries) within a particular timeframe. For example, in the United Kingdom, a tourist must leave the country (and the EU) within three months of a purchase to be eligible for a VAT reimbursement. Accordingly, the submission of VAT reimbursement requests may be delayed until consumer 108 has either left the country, or a government official or other personnel confirms that consumer 108 is in the process of leaving the country.

In step 502, after entering into several VAT reimbursement-eligible transactions in a first country, consumer 108 proceeds to a port of egress for that country. The port may include an airport, railway station, harbor, or other facility from which consumer 108 can leave the country. In the present method, the port includes a customs facility for customs agents to process passengers leaving the country and to review any requests for VAT reimbursement presented by consumer 108. In other applications, however, non-governmental personnel process consumer 108, review the VAT reimbursement-eligible transactions and confirm that consumer 108 is in the process of leaving the country. In other systems, the process is automated and consumer 108 only interacts with customs terminal 132 to process the reimbursement transactions and to confirm egress from the country.

In step 504, consumer 108 provides identification and payment account information to a customs official to initiate the reimbursement process. In one implementation of system 100, consumer 108's passport is scanned at customs terminal 132 to identify consumer 108. Similarly, the portable consumer payment devices used in the transactions such as credit or debit cards are scanned into customs terminal 132 to identify consumer 108's payment accounts. Requiring consumer 108 to present portable consumer payment devices for reimbursement may provide a fraud prevention function as it requires the cards be present and ensures that they have not been stolen or otherwise taken from consumer 108's person. In the present system, customs terminal 108 is implemented as a customer interaction device configured to communicate with transaction handler 102. For example, customs terminal 108 may include a “credit-only” POS system having a registered terminal identification and card acceptor identification for communicating with transaction handler 102. Customs terminal 108 may communicate with transaction handler 102 via Internet 112 or dedicated communication systems 120, and 122. In alternative implementations, if authorized by local laws and/or regulations, consumer 108 may interact directly with customs terminal 132 with no assistance from a customs officer or other personnel. Furthermore, the offering of a passport as an identification device may be optional—other or no forms of identification may be used. If no identification is offered, the system may rely on the payment account information to identify the transactions to be reimbursed.

In step 506, customs terminal 132 transmits consumer 108's identification information and payment account information to transaction handler 102. Using the consumer 108 identification information and payment account information, transaction handler 102 retrieves the stored transaction data for available VAT reimbursement-eligible transactions and transmits it to customs terminal 132. The data received by customs terminal 132 may include images of all receipts, line-item descriptions of items purchased and VAT amount applied, the date the transaction took place, the merchant that executed the transaction, the location of the transaction and any other data transmitted from merchant 110 to transaction handler 102 as part of the original transaction.

In step 508, customs terminal 132 receives the transaction data from transaction handler 102 and displays it for review by the customs official. Using customs terminal 132, the official can review the transaction information, and see copies of the original receipts. If necessary, the customs official can perform an inspection of consumer 108's goods to ensure that the items identified by customs terminal 132 are leaving the country within the required time frame. Depending upon local regulations and requirements for VAT reimbursement, inspection may be mandatory, not-required, or undertaken at the discretion of the customs official. After reviewing the transaction data and, if necessary, consumer 108's belongings, the customs official, in step 510, uses customs terminal 132 to indicate whether particular transactions are approved using a user interface provided by the terminal 132.

In step 512, customs terminal 132 communicates with transaction handler 102 to indicate which transactions are approved and which are disapproved. The customs official may also use customs terminal 132 to indicate that consumer 108 has been processed and is leaving the country. At this time, customs terminal 132 can print a receipt for consumer 108 indicating the result of the transaction, provide information about how the reimbursement requests will be processed and their expected mailing date, an explanation of the reimbursement amounts, which transactions were approved, and any other useful information for consumer 108.

Having received a listing of approved reimbursement requests from customs terminal 132, transaction handler 102 initiates payment of the reimbursements that were approved via customs terminal 132 in step 512. To submit a transaction for reimbursement processing, transaction handler 102 retrieves all transaction records that are required for submitting a reimbursement request. The necessary records may include copies of the transaction receipts, line-item descriptions of items purchased and VAT amount applied, the date the transaction took place, the merchant that executed the transaction, the location of the transaction and any other data transmitted from merchant 110 to transaction handler 102 as part of the original transaction. The transaction handler 102 may submit the reimbursement requests to government tax authority 130 for reimbursement payment. Government tax authority 130 includes any governmental entity that can receive reimbursement requests and process reimbursement payments. In some applications, government tax authority 130 may include public and private entities, or any other entity tasked with receiving and processing the reimbursement requests. In other implementations, the reimbursement requests are submitted to issuer 104 of consumer 108's payment account. Issuer 104 receives the reimbursement request and credits consumer 108's payment account with the reimbursement amount minus any transaction fees, for example, using a statement credit. In some cases, the credit is applied to consumer 108's payment account using customs terminal 132 at the time of VAT reimbursement processing. Issuer 104 can then be made whole by requesting the VAT reimbursement amount from merchants 110, government tax authority 130, or another party charged with paying VAT reimbursement charges. In other implementations, transaction handler 102 submits the VAT reimbursement requests to any entity in communication with transaction handler 102 and tasked with making VAT reimbursement payments.

It should be understood implementations can be in the form of control logic, in a modular or integrated manner, using software, hardware or a combination of both. The steps of a method, process, or algorithm described in connection with the implementations disclosed herein may be embodied directly in hardware, in a software module executed by a processor, or in a combination of the two.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements.

It is further understood that the examples and implementations described herein are for illustrative purposes only and that various modifications or changes in light thereof will be suggested to persons skilled in the art and are to be included within the spirit and purview of this application and scope of the appended claims.

What is claimed is:

1. A method comprising a plurality of steps each being performed by a computing apparatus executing software, wherein the steps include:
receiving a plurality of payment authorization requests for a plurality of transactions on respective accounts, each said transaction being conducted for a purchase from a merchant on a corresponding said account, wherein each said authorization request requests payment for the purchase from the corresponding said account for the benefit of the merchant in a currency different than the currency of the corresponding said account;
sending, in response to the payment authorization requests, the authorization requests;
receiving, in response to the authorization requests, authorization request responses for the plurality of transactions;
sending the authorization request responses, wherein a plurality of the authorization request responses are allowed such that the corresponding payment for the purchase is authorized to be paid from the corresponding said account;
for each said transaction for which the authorization request response is allowed:
facilitating the clearing and settlement of the transaction; and
determining whether the account of the transaction is in a Value Added Tax (VAT) reimbursement database, and if so then storing data from the transaction in a VAT reimbursement transactions database;
receiving, from a plurality of different government entities, a plurality of VAT reimbursement requests each corresponding to one said transaction on one said account; and
for each said received VAT reimbursement request, determining whether the account of the transaction is in a Value Added Tax reimbursement database, and if so then determining whether the corresponding said data from the transaction is stored in the VAT reimbursement transactions database, and if so, then facilitating a clearing and settlement of a VAT reimbursement payment for the transaction between the account of the transaction and the corresponding said government entity.

2. The method as defined in claim 1, wherein the step of facilitating the clearing and settlement of the transaction further comprises converting the currency of the purchase to the currency of the corresponding said the account upon which the transaction was conducted with the merchant.

3. The method as defined in claim 1, wherein the step of facilitating the clearing and settlement of the transaction further comprises an entity acting as both acquirer for the merchant and issuer of the account upon which the transaction was conducted with the merchant.

4. The method as defined in claim 1, wherein the step of facilitating the clearing and settlement of the transaction further comprises a first entity acting as an acquirer for the merchant and a second, different entity, acting as an issuer of the account upon which the transaction was conducted with the merchant.

5. The method as defined in claim 1, wherein the step of facilitating a clearing and settlement of a VAT reimbursement payment for the transaction comprises:
sending a VAT reimbursement amount request for delivery to the corresponding said government entity;
receiving, in response to the VAT reimbursement amount request, the VAT reimbursement payment; and
sending the VAT reimbursement payment to credit to the account upon which the transaction was conducted with the merchant.

6. The method as defined in claim 1, wherein the step of facilitating a clearing and settlement of a VAT reimbursement payment for the transaction between the account of the transaction and the corresponding said government entity further comprises converting the VAT reimbursement payment into the currency of the corresponding said the account upon which the transaction was conducted with the merchant.

7. The method as defined in claim 1, wherein:
the currency of each said purchase is Euros; and
each said governmental entity is a member of the European Community.

8. A method comprising a plurality of steps each being performed by a computing apparatus executing software, wherein the steps include:
receiving, from a plurality of different acquirers, a plurality of payment authorization requests for a plurality of transactions on respective accounts issued by a plurality of different issuers, each said transaction being conducted for a purchase from a merchant on a corresponding said account issued by one said issuer to an account holder, wherein each said authorization request requests payment for the purchase from the corresponding said account to the corresponding said acquirer for the benefit of the merchant in a currency different than the currency of the corresponding said account;
sending, in response to the payment authorization requests, the authorization requests to the respective issuers of the respective accounts upon which the plurality of transactions are being conducted;
receiving, in response to the authorization requests, authorization request responses from the respective issuers for the plurality of transactions;
sending the authorization request responses to the respective acquirers for the plurality of transactions, wherein a plurality of the authorization request responses are allowed such that the corresponding said issuer has authorized the corresponding payment for the purchase from the corresponding said account to the corresponding said acquirer for the benefit of the merchant;
for each said transaction for which the authorization request response is allowed:
facilitating the clearing and settlement of the transaction between the corresponding said issuer and the corresponding said acquirer; and
determining whether the account of the transaction is in a Value Added Tax (VAT) reimbursement database, and if so then storing data from the transaction in a VAT reimbursement transactions database;
receiving, from a plurality of different government entities, a plurality of VAT reimbursement requests each corresponding to one said transaction on one said account; and
for each said received VAT reimbursement request, determining whether the account of the transaction is in a Value Added Tax reimbursement database, and if so then determining whether the corresponding said data from the transaction is stored in the VAT reimbursement transactions database, and if so, then facilitating a clearing and settlement of a VAT reimbursement payment for the transaction between the corresponding said issuer of the account of the transaction and the corresponding said government entity.

9. The method as defined in claim 8, wherein the step of facilitating the clearing and settlement of the transaction between the corresponding said issuer and the corresponding said acquirer further comprises converting the currency of the purchase to the currency of the corresponding said the account upon which the transaction was conducted with the merchant.

10. The method as defined in claim 8, wherein the step of facilitating a clearing and settlement of a VAT reimbursement payment for the transaction between the corresponding said issuer of the account of the transaction and the corresponding said government entity comprises:
sending a VAT reimbursement amount request for delivery to the corresponding said government entity;
receiving, in response to the VAT reimbursement amount request, the VAT reimbursement payment; and
sending the VAT reimbursement payment, for delivery to the issuer of the account of the transaction, to credit to the account upon which the transaction was conducted with the merchant.

11. The method as defined in claim 8, wherein the step of facilitating a clearing and settlement of a VAT reimbursement payment for the transaction between the corresponding said issuer of the account of the transaction and the corresponding said government entity further comprises converting the VAT reimbursement payment into the currency of the corresponding said the account upon which the transaction was conducted with the merchant.

12. The method as defined in claim 8, wherein:
the currency of each said purchase is Euros; and
each said governmental entity is a member of the European Community.

13. A method comprising a plurality of instructions which, when executed by a computing apparatus, the computing apparatus performs a plurality of steps, wherein the steps include:
receiving, from a plurality of different acquirers, a plurality of payment authorization requests for a plurality of transactions on respective accounts issued by a plurality of different issuers, each said transaction being conducted for a purchase from a merchant on a corresponding said account issued by one said issuer to an account holder, wherein each said authorization request requests payment for the purchase from the corresponding said account to the corresponding said acquirer for the benefit of the merchant in Euros and the currency of the corresponding said account is not Euros;
sending the authorization requests to the respective issuers of the respective accounts upon which the plurality of transactions are being conducted;
receiving, in response to the authorization requests, authorization request responses from the respective issuers for the plurality of transactions;
sending the authorization request responses to the respective acquirers for the plurality of transactions, wherein at least said authorization request response is an allowed authorization such that the corresponding said issuer has authorized the corresponding payment for the purchase from the corresponding said account to the corresponding said acquirer for the benefit of the merchant;
for each said transaction for which the authorization request response is an allowed authorization:
facilitating the clearing and settlement of the transaction between the corresponding said issuer and the corresponding said acquirer, including converting the currency of the purchase to the currency of the corresponding said the account upon which the transaction was conducted with the merchant; and
determining whether the account of the transaction is in a Value Added Tax (VAT) reimbursement database, and if so then storing data from the transaction in a VAT reimbursement transactions database;
receiving, from a plurality of different members of the European Community, a plurality of VAT reimbursement requests each corresponding to one said transaction on one said account; and
for each said received VAT reimbursement request, determining whether the account of the transaction is in a Value Added Tax reimbursement database, and if so then determining whether the corresponding said data from the transaction is stored in the VAT reimbursement transactions database, and if so, then:
sending a VAT reimbursement amount request for delivery to the corresponding said member of the European Community;
receiving, in response to the VAT reimbursement amount request, the VAT reimbursement payment in Euros;
converting the VAT reimbursement payment in Euros to the currency of the corresponding said the account upon which the transaction was conducted with the merchant; and
sending the converted VAT reimbursement payment, for delivery to the issuer of the account of the transaction, for crediting to the account upon which the transaction was conducted with the merchant.

14. A computing apparatus comprising:
means for receiving, from a plurality of different acquirers, a plurality of payment authorization requests for a plurality of transactions on respective accounts issued by a plurality of different issuers, each said transaction being conducted for a purchase from a merchant on a corresponding said account issued by one said issuer to an account holder, wherein each said authorization request requests payment for the purchase from the corresponding said account to the corresponding said acquirer for the benefit of the merchant in a currency different than the currency of the corresponding said account;
means for sending, in response to the payment authorization requests, the authorization requests to the respective issuers of the respective accounts upon which the plurality of transactions are being conducted;
means for receiving, in response to the authorization requests, authorization request responses from the respective issuers for the plurality of transactions;
means for sending the authorization request responses to the respective acquirers for the plurality of transactions, wherein a plurality of the authorization request responses are allowed such that the corresponding said issuer has authorized the corresponding payment for the purchase from the corresponding said account to the corresponding said acquirer for the benefit of the merchant;
for each said transaction for which the authorization request response is allowed:
means for facilitating the clearing and settlement of the transaction between the corresponding said issuer and the corresponding said acquirer; and
means for determining whether the account of the transaction is in a Value Added Tax (VAT) reimbursement database, and if so then storing data from the transaction in a VAT reimbursement transactions database;
receiving, from a plurality of different government entities, a plurality of VAT reimbursement requests each corresponding to one said transaction on one said account; and
for each said received VAT reimbursement request, means for determining whether the account of the transaction is in a Value Added Tax reimbursement database, and if so then means for determining whether the corresponding said data from the transaction is stored in the VAT reimbursement transactions database, and if so, then means for facilitating a clearing and settlement of a VAT reimbursement payment for the transaction between the corresponding said issuer of the account of the transaction and the corresponding said government entity.

15. The computing apparatus as defined in claim 14, wherein the step of facilitating the clearing and settlement of the transaction between the corresponding said issuer and the corresponding said acquirer further comprises converting the currency of the purchase to the currency of the corresponding said the account upon which the transaction was conducted with the merchant.

16. The computing apparatus as defined in claim 14, wherein the step of facilitating a clearing and settlement of a VAT reimbursement payment for the transaction between the corresponding said issuer of the account of the transaction and the corresponding said government entity comprises:
sending a VAT reimbursement amount request for delivery to the corresponding said government entity;
receiving, in response to the VAT reimbursement amount request, the VAT reimbursement payment; and
sending the VAT reimbursement payment, for delivery to the issuer of the account of the transaction, to credit to the account upon which the transaction was conducted with the merchant.

17. The computing apparatus as defined in claim 14, wherein the step of facilitating a clearing and settlement of a VAT reimbursement payment for the transaction between the corresponding said issuer of the account of the transaction and the corresponding said government entity further comprises converting the VAT reimbursement payment into the currency of the corresponding said the account upon which the transaction was conducted with the merchant.

18. The computing apparatus as defined in claim 14, wherein:
the currency of each said purchase is Euros; and
each said governmental entity is a member of the European Community.

19. A computing apparatus comprising:
means for receiving, from a plurality of different acquirers, a plurality of payment authorization requests for a plurality of transactions on respective accounts issued by a plurality of different issuers, each said transaction being conducted for a purchase from a merchant on a corresponding said account issued by one said issuer to an account holder, wherein each said authorization request requests payment for the purchase from the corresponding said account to the corresponding said acquirer for the benefit of the merchant in a first currency and the currency of the corresponding said account is not the first currency;
means for sending the authorization requests to the respective issuers of the respective accounts upon which the plurality of transactions are being conducted;
means for receiving, in response to the authorization requests, authorization request responses from the respective issuers for the plurality of transactions;
means for sending the authorization request responses to the respective acquirers for the plurality of transactions, wherein at least said authorization request response is an allowed authorization such that the corresponding said issuer has authorized the corresponding payment for the purchase from the corresponding said account to the corresponding said acquirer for the benefit of the merchant;
for each said transaction for which the authorization request response is an allowed authorization:
means for facilitating the clearing and settlement of the transaction between the corresponding said issuer and the corresponding said acquirer, including converting the currency of the purchase to the currency of the corresponding said the account upon which the transaction was conducted with the merchant; and
means for determining whether the account of the transaction is in a Value Added Tax (VAT) reimbursement database, and if so then storing data from the transaction in a VAT reimbursement transactions database;
means for receiving, from a plurality of different governmental entities, a plurality of VAT reimbursement requests each corresponding to one said transaction on one said account; and
for each said received VAT reimbursement request, means for determining whether the account of the transaction is in a Value Added Tax reimbursement database, and if so then means for determining whether the corresponding said data from the transaction is stored in the VAT reimbursement transactions database, and if so, then:
means for sending a VAT reimbursement amount request for delivery to the corresponding said governmental entity;
means for receiving, in response to the VAT reimbursement amount request, the VAT reimbursement payment in the first currency;
means for converting the VAT reimbursement payment from the first currency to the currency of the corresponding said the account upon which the transaction was conducted with the merchant; and
means for sending the converted VAT reimbursement payment, for delivery to the issuer of the account of the transaction, for the crediting to the account upon which the transaction was conducted with the merchant.

20. The computing apparatus as defined in claim 19, wherein:
each said governmental entity is a member of the European Community; and
the currency of each said purchase is Euros.
